(19) United States
(12) Patent Application Publication
(10) Pub. No.: US 2012/0209561 A1
(43) Pub. Date: Aug. 16, 2012

(54) METHODS AND SYSTEMS FOR IDENTIFYING A POINT OF INTEREST ON THE PERIPHERY OF AN OBJECT

(75) Inventors: John Toland Van Stan, II, Newark, DE (US); Matthew T. Jarvis, Newark, DE (US); Delphis F. Levia, JR., Elkton, MD (US)

(73) Assignee: University of Delaware, Newark, DE (US)

(21) Appl. No.: 13/370,803

(22) Filed: Feb. 10, 2012

Related U.S. Application Data
(60) Provisional application No. 61/441,502, filed on Feb. 10, 2011.

(51) Int. Cl. G06F 15/00

(52) U.S. Cl. 702/150

(57) ABSTRACT

Methods and systems for identifying a point of interest on the periphery of an object are disclosed. A system comprises a track, a carriage, an advancement mechanism, a non-contact measurement device, and a processor. The advancement mechanism is configured to advance the carriage along the path defined by the track. The measurement device comprises a transmitter configured to transmit a beam of radiation toward the periphery of the object and a detector configured to detect at least a portion of the radiation reflected from the periphery of the object. The processor is programmed to (i) advance the carriage along the path, (ii) measure a distance between the periphery of the object and the measurement device, (iii) calculate a center of mass of the object from the measured distances, and (iv) determine the point of interest on the periphery of the object using the calculated center of mass of the object.

### CROSS REFERENCE TO RELATED APPLICATIONS

This application claims priority to U.S. Patent Application No. 61/441,502, entitled “APPARATUS FOR DEFINING A POINT OF INTEREST ON THE PERIPHERY OF AN OBJECT,” filed on Feb. 10, 2011, the contents of which are incorporated herein by reference in their entirety.

### FIELD OF THE INVENTION

The present invention relates generally to measurement systems, and more particularly, to methods and systems for identifying a point of interest on the periphery of an object.

### BACKGROUND OF THE INVENTION

In recent years, it has become desirable to determine the amount of precipitation (rain, snow, etc.) that is intercepted by a forest canopy prior to reaching the forest floor. Precipitation may be stored by, and evaporated from, canopy bark and foliar surfaces (e.g. branches and leaves) during rain or snowfall. This can diminish incident precipitation inputs beneath the forest canopy by as much as 50%, depending on species of tree and season.

Conventionally, estimates of canopy precipitation storage and evaporation have been primarily based on indirect methods and model estimates, which may produce significant error. Alternatively, direct measurements of precipitation fluxes at varying temporal resolutions have been performed using weighing lysimeters. However, improved methods and systems for measuring the amount of precipitation intercepted by a forest canopy are desired.

### SUMMARY OF THE INVENTION

Aspects of the present invention relate to methods and systems for identifying a point of interest on the periphery of an object.

In accordance with one aspect of the present invention, a system for identifying a point of interest on a periphery of an object is disclosed. The system comprises a track, a carriage, an advancement mechanism, a non-contact measurement device, and a processor. The track is configured to be attached to the object. The track defines a path around at least a portion of the object. The carriage is adapted to traverse the path defined by the track. The advancement mechanism is configured to advance the carriage along the path. The non-contact measurement device is mounted on the carriage. The non-contact measurement device comprises a transmitter configured to transmit a beam of radiation toward the periphery of the object and a detector configured to detect at least a portion of the radiation reflected from the periphery of the object. The processor is in communication with the measurement device. The processor is programmed to (i) control the advancement mechanism to advance the carriage along the path, (ii) measure a distance between the periphery of the object and the measurement device at a plurality of locations of the carriage along the path, (iii) calculate a center of mass of the object from the measured distances, and (iv) determine the point of interest on the periphery of the object using the calculated center of mass of the object.

In accordance with another aspect of the present invention, a method for identifying a point of interest on a periphery of an object is disclosed. The method comprises the steps of attaching a track to the object, positioning a carriage on a path defined by the track, advancing the carriage along the path using an advancement mechanism coupled to the carriage, measuring with a measurement device a distance between the periphery of the object and the measurement device at a plurality of locations of the carriage along the path, calculating a center of mass of the object from the measured distances, and determining the point of interest on the periphery of the object using the calculated center of mass of the object.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. To the contrary, the dimensions of the various features may be expanded or reduced for clarity. Included in the drawings are the following figures:

FIG. 1 is a diagram illustrating the forces acting on an exemplary tree in accordance with aspects of the present invention;

FIG. 2 is a diagram illustrating an exemplary system for identifying a point of interest on the periphery of an object in accordance with aspects of the present invention;

FIG. 3 is a diagram illustrating an exemplary carriage of the system of FIG. 2;

FIG. 4 is an image illustrating exemplary sensors mounted according to an object using the system of FIG. 2;

FIGS. 5A and 5B are graphs illustrating the cross-sections of exemplary objects measured with the system of FIG. 2; and

FIG. 6 is a flowchart illustrating an exemplary method for identifying a point of interest on the periphery of an object in accordance with aspects of the present invention.

### DETAILED DESCRIPTION OF THE INVENTION

The various aspects of the present invention relate generally to systems and methods for identifying a point of interest on the periphery of an object. The embodiments include structures that may be mounted to or around the desired object. The disclosed embodiments further include components adapted to measure and analyze the object in order to identify the points of interest on the periphery of the object.

The systems and methods described herein are particularly suitable for identifying points of interest on the trunk of a tree. The disclosed systems may be particularly suited for identifying optimal locations on the trunk of a tree for the positioning of sensors on the tree. Additional details regarding the identification of points of interest for mounting such sensors, and on the sensors themselves, will be described in greater detail herein.

While the invention is described herein primarily with respect to use for identifying points of interest on tree trunks, it will be understood that the invention is not so limited. The disclosed embodiments may be usable on any object on which it is desirable to identify points of interest.

As set forth above, aspects of the present invention relate generally to identify points of interest for the mounting of sensors on a tree trunk. It has been determined that direct measurements of precipitation by a forest canopy can be obtained at high temporal resolution (˜5 seconds) and sensitivity (<5 kg) using mechanical displacement sensors affixed to the tree trunk with a minimally-invasive superstructure. Mechanical displacement sensors may be able to measure compression and relaxation of a trunk axial section caused by changes in canopy biomass (e.g. from intercepted precipitation). Specification, axial loads creating trunk compression at the storm event scale are largely attributed to the increased weight of intercepted precipitation within the canopy and, conversely, relaxations from the compressed state which represent intrastorm evaporation of intercepted precipitation.

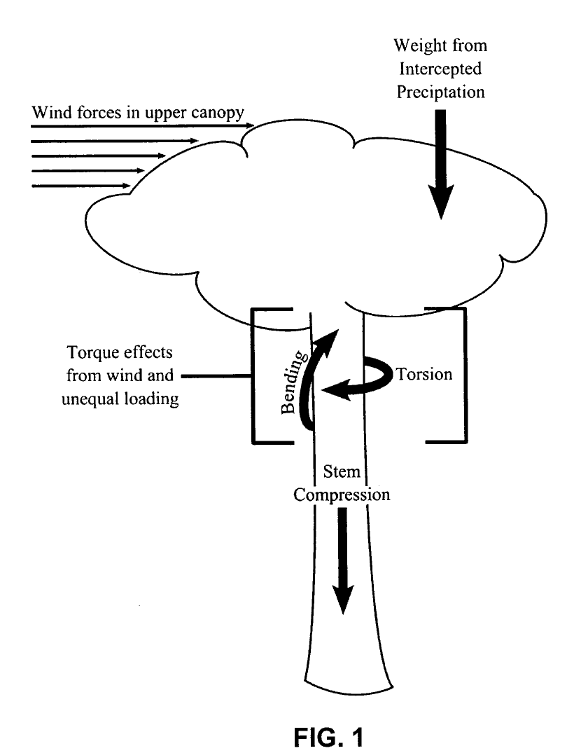

However, it has further been determined that wind and off-center loading within the canopy can produce bending anomalies many orders of magnitude greater than compressive forces of the same strength regardless of tree height and diameter. As illustrated in FIG. 1, for example, tree trunks may experience compression or relaxation caused by a number of forces acting on the tree, such as wind, precipitation, or uneven distribution of branches and/or foliage. Such distortions in sensor measurement can be removed if the sensors are orthogonally aligned along axes of no longitudinal stresses or strain, e.g., axes aligned with the center of mass of the tree. Precision of sensor placement is critical as measurement error can increase linearly with distance from a neutral bending axis or orthogonal alignment. Accordingly, aspects of the present invention are related to systems and methods for identifying precisely determined points of interest for the installation of compression sensors along the trunk of a tree, for the purpose of accurately detecting interception of precipitation by the tree canopy.

An exemplary apparatus usable with the disclosed systems and methods is described in U.S. patent application Ser. No. 12/780,517, titled “METHOD AND APPARATUS FOR MEASURING MICRORELIEF OF AN OBJECT,” filed on May 14, 2010, the contents of which are incorporated herein by reference in their entirety. It should be understood, however, that the details of the above-referenced application are in no way intended to limit aspects of the invention described herein. Aspects of the present invention constitute improvements upon the apparatus described in U.S. patent application Ser. No. 12/780,517, as set forth below.

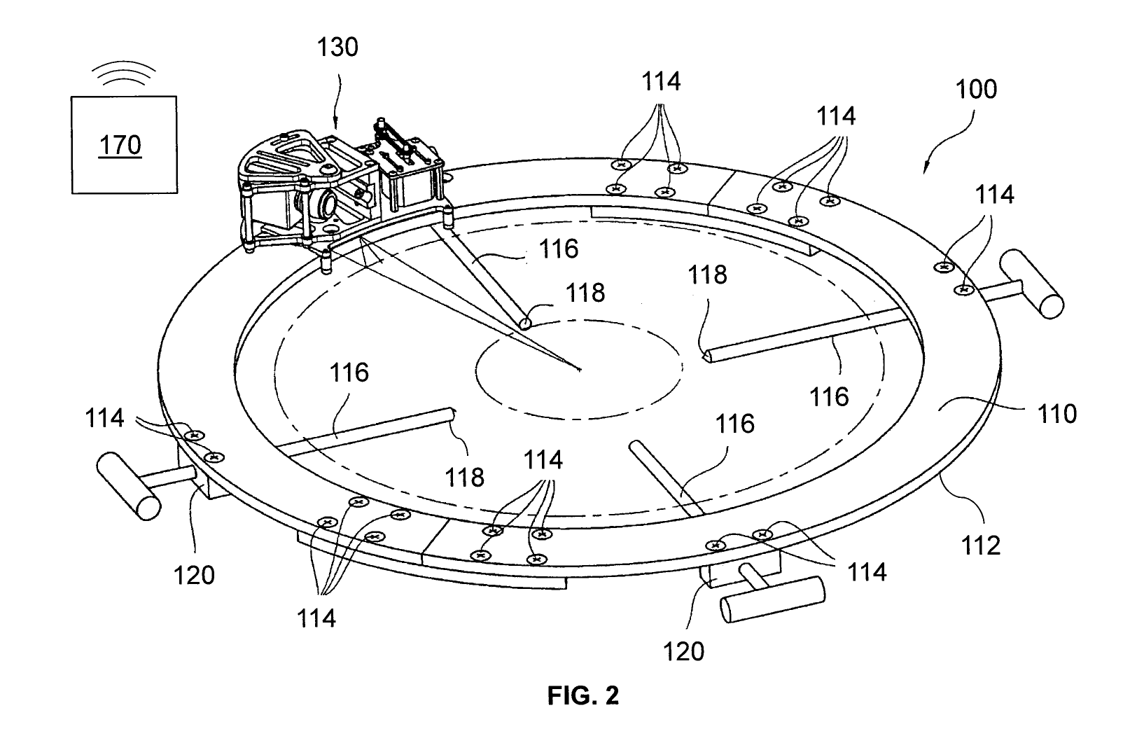

Referring now to the drawings, FIGS. 2-4 illustrate an exemplary system 100 for identifying a point of interest on a periphery of an object in accordance with aspects of the present invention. System 100 may be particularly suitable to identify suitable sensor mounting locations on the trunk of a tree. As a general overview, powered mobility system 100 includes a track 110, a carriage 130, an advancement mechanism 140, a non-contact measurement device 150, and a processor 170. Additional details of system 100 are described herein.

Track 110 defines a path around at least a portion of the object. As shown in FIG. 2, track 110 may define a path around the entire periphery of the object. Track 110 may define the path such that the path is disposed at a fixed distance from a central axis of the object, and/or is disposed in a single plane. In an exemplary embodiment, track 110 comprises a ring 112 that completely surrounds the central axis of the object. Ring 112 is formed from two ring halves, so that track 110 may be assembled around the object. Ring halves are connected to one another by fasteners 114, as shown in FIG. 2. Suitable fasteners 114 will be known to one of ordinary skill in the art from the description herein. It may be desirable that fasteners 114 not protrude above the upper surface of ring 112, so that they do not interfere with the operation and movement of carriage 130.

Track 110 may be configured to be removably attached to the object in order to fix the path in place relative to the object. In an exemplary embodiment, track 110 includes a plurality of anchors 116 for removably attaching track 110 to the object, as shown in FIG. 2. Anchors 116 may be radially adjustable to accommodate objects that vary in size. Anchors 116 may have sharpened ends 118 to enable anchors 116 to secure the position of track 110 relative to the object. Anchors 116 are mounted to ring 112 of track 110 via support blocks 120. Support blocks 120 may be threaded to enable radial adjustment of anchors 116, in order to secure track 110 to the object.

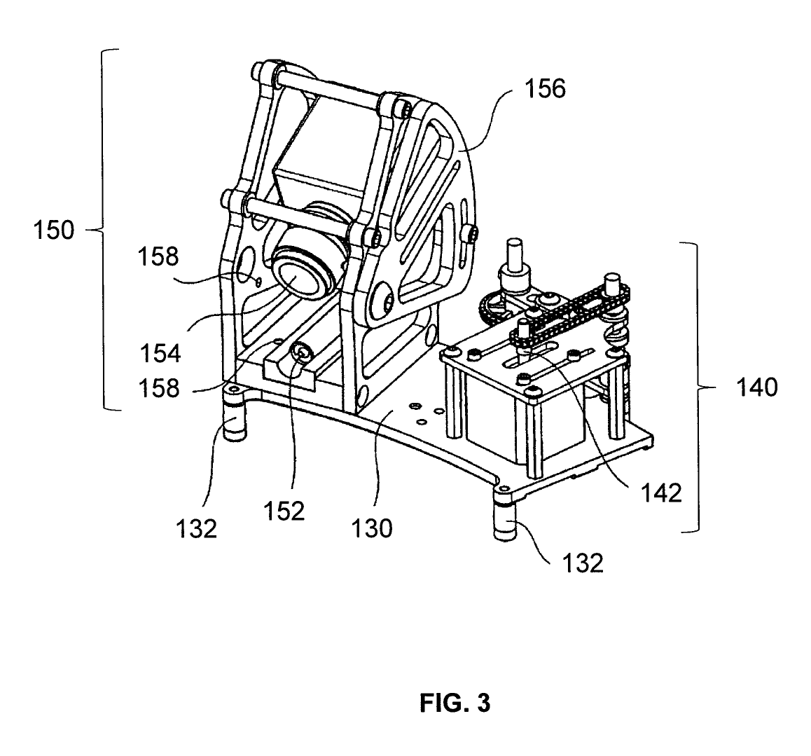

Carriage 130 is adapted to traverse the path defined by track 110. Carriage 130 is configured to ride on track 110, and hold a plurality of devices for use during operation of system 100. Carriage 130 may include one or more unpowered wheels 132 for keeping carriage 130 aligned within track 110, as shown in FIG. 3. Carriage 130 may comprise an aluminum or fiberglass chassis, and may desirably include a durable, waterproof plastic housing to enable outdoor use. The carriage assembly may be powered by, for example, a removable lithium-polymer or similar high density battery attached to the chassis. Additional details on the devices supported by carriage 130 are provided herein.

Advancement mechanism 140 is configured to advance carriage 130 along the path defined by track 110. In an exemplary embodiment, advancement mechanism 140 comprises a motor 142 such as, for example, a servo motor. Motor 142 is supported on carriage 130. Motor 142 is coupled to one or more powered wheels (not shown) that are driven by motor 142 in order to advance carriage 130 along the path defined by track 110.

Non-contact measurement device 150 is mounted on carriage 130. Measurement device 150 is operable to measure a distance between itself and the periphery of the object. In an exemplary embodiment, measurement device 150 comprises a transmitter 152 and a detector 154, as shown in FIG. 3. Transmitter 152 is configured to transmit a beam of radiation toward the periphery of the object. Detector 154 is configured to detect at least a portion of the radiation that is reflected by the periphery of the object.

In a particular embodiment, transmitter 152 comprises a laser emitter, and detector 154 comprises an image sensor, such as a charge-coupled device (CCD) sensor. Suitable laser emitters and CCD sensors will be known to one of ordinary skill in the art from the description herein. The distance between measurement device 150 and the periphery of the object may be determined through triangulation between the emission point of the laser emitter and the brightest pixel recorded by the CCD sensor.

Transmitter 152 and detector 154 may be mounted to carriage 130 using a frame 156, as shown in FIG. 3. Frame 156 may be mounted to carriage 130 via one or more threaded screw holes 158, as would be understood by one of ordinary skill in the art. In an exemplary embodiment, frame 156 enables adjustment of the vertical angle of transmitter 152 and detector 154 relative to carriage 130. It may be desirable that frame 156 restrict movement in the horizontal direction of transmitter 152 and detector 154, such that these components are always oriented in the direction of the central axis of track 110.

Processor 170 is in communication with non-contact measurement device 150. Processor 170 controls the operation of the components supported on carriage 130 (e.g., advancement mechanism 140 and measurement device 150). Processor 170 may be connected to the components of system 100 wirelessly, as shown in FIG. 2, or may include wired connections to the components mounted on carriage 130. The particular operations performed by processor 170 are explained below in detail. In one exemplary embodiment, processor 170 comprises a laptop computer configured to wirelessly control the operation of system 100. However, processor 170 is not so limited. Processor 170 may comprise any controller or processing element programmable to instruct the components of system 100 to perform the operations described herein. In another exemplary embodiment, processor 170 comprises a microcontroller mounted directly on carriage 130. Suitable microcontrollers for use with the present invention will be known to one of ordinary skill in the art from the description herein.

System 100 is not limited to the above components, but may include alternative or additional components, as would be understood by one of ordinary skill in the art.

For one example, system 100 may include an indicator mounted on carriage 130. The indicator is configured to identify the point of interest on the periphery of the object. The indicator may further be an optical indicator, such that the indicator is operable to optically identify the point of interest on the periphery of the object. In an exemplary embodiment, transmitter 152 of measurement device 150 may be used as the indicator in accordance with aspects of the present invention. In this embodiment, transmitter 152 may desirably comprise an optical laser emitter (e.g. a laser pointer). In an alternative exemplary embodiment, system 100 may include a separate laser emitter (not shown) for use as the indicator.

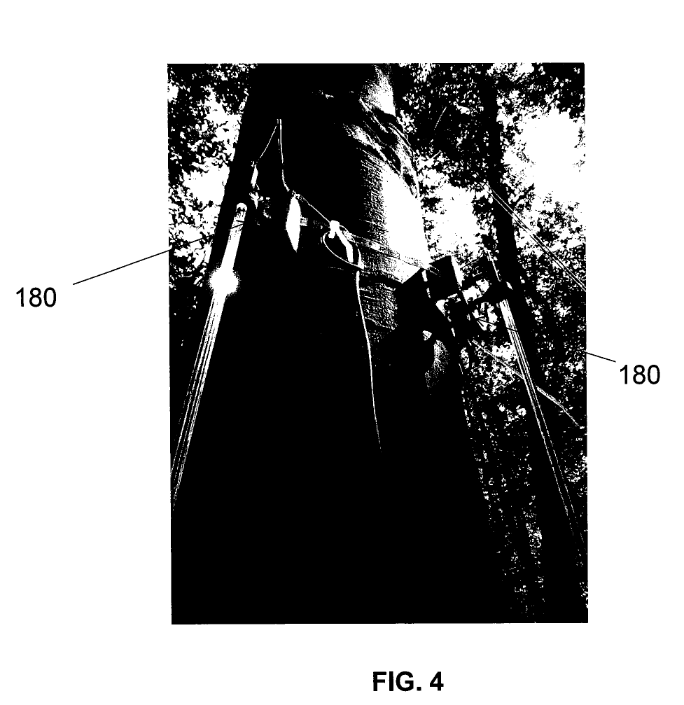

For another example, system 100 may include one or more sensors 180. Sensors 180 are adapted to be mounted on the periphery of the object at the point(s) of interest identified by the indicator of system 100. In an exemplary embodiment, the object may be a tree for which it is desirable to measure compression (for use in the research of interception of precipitation by the tree during precipitation events). In this embodiment, sensors 180 may be adapted to be mounted on the bark of the tree. Sensors 180 may further be adapted to measure compression of the tree during storm events. In an exemplary embodiment, sensors 180 comprise conventional potentiometers extended in length (e.g., to 1 meter) with a quartz rod, as shown in FIG. 4. Suitable potentiometers for use as sensors 180 include, for example, the Model 3046 Linear Motion Potentiometer provided by Bournes, Inc., of Riverside, Calif., USA. Other suitable sensors will be known to one of ordinary skill in the art from the description herein, and may be selected based on desired characteristics of the object to be measured.

Exemplary operations of system 100 for identifying a point of interest on the periphery of will now be described in accordance with aspects of the present invention. As explained above, the invention may be particular suitable for use in identifying points of interest on the periphery of a tree. The exemplary operations set forth below are described with respect to such an embodiment.

In an exemplary operation, track 110 is attached to a suitable tree using anchors 116. Suitable trees may have particularly straight trunk to minimize the extraneous forces acting on sensors 180. Track 110 may be attached at a position spaced from the base of the tree, e.g., between 6-8 feet up on the tree.

Carriage 130 is then placed at an arbitrary starting point on track 110. Processor 170 controls advancement mechanism 140 to advance carriage 130 along the path defined by track 110.

As carriage 130 advances around track 110, transmitter 152 of non-contact measurement device 150 projects a beam of radiation onto the periphery of the tree. At a plurality of locations along the path, detector 154 captures image data from the measurement region (i.e. the periphery of the tree). With this image data, processor 170 triangulates the range to the object based on the location of the laser light in the image data. In this way, processor 170 measures a distance between the periphery of the tree and measurement device 150 at a plurality of locations of carriage 130 along the path.

It will be understood by one of ordinary skill in the art that system 100 is not limited to only the above algorithm for measuring a distance. Other methods of calculation may be used to determine the distance between the periphery of the object and the measurement device, including but not limited to single laser time of flight, scanning beam laser triangulation, scanning beam laser time of flight, structured light, motorized touch probe, ultrasonic/infrared ranging, binocular stereo depth mapping, optic flow mapping, photogrammetric coordinate measurement, or any other method of calculation for an automated distance measurement that is known in the art.

The measurement steps described above are repeated until the entire circumference of the tree has been traversed and sampled using system 100. Processor 170 may process this data by subtracting the measurements obtained using measurement device 150 from the diameter of track 110, and plotting the result in polar coordinates (i.e., to form a graphical cross-section of the tree). To obtain accurate measurements of the periphery of the tree, it will be understood that sampling resolution of system 100 must be particularly refined. In an exemplary embodiment, processor 170 is operable to take measurements using measurement device 150 at angular increments of down to one tenth of one degree (i.e., approximately 3600 measurements along one complete circuit of track 110). Further, measurement device 150 is operable to measure distances at a resolution of one tenth of one millimeter.

After processor 170 has obtained and plotted the distance measurements between device 150 and the tree and the plurality of locations, processor 170 calculates a center of mass of the tree using the measured distances. As set forth above, the path defined by track 110 may be disposed within a single plane. Accordingly, processor 170 may be programmed to calculate the center of mass of the tree within the single plane within which the path is disposed. An exemplary algorithm for calculating a center of mass is set forth below in accordance with aspects of the present invention.

Once the measurements are complete, the graphical cross section (described above) is broken into triangles, formed between two adjacent measurement points and the origin (i.e., the central axis of track 110). Neutral bending axes may be derived from the centroids or each triangle and the areas of the triangles, using the following equations.

$${x}_{ci} , {y}_{ci} = \frac{{x}_{i} + {x}_{i + 1}}{3} , \frac{{y}_{i} + {y}_{i + 1}}{3}$$

$${A}_{i} = \frac{1}{2} \vert {x}_{i} {y}_{i + 1} + {x}_{i + 1} {y}_{i} \vert$$

where (x_{ci}, y_{ci}) is the centroid and Aᵢ is the area of any triangle enclosed by the points (xᵢ, yᵢ) and (xᵢ₊₁, yᵢ₊₁), and the origin. With the centroid and the area determined for each triangle, the centroid of the entire irregular stem profile can be computed as:

$${x}_{c} , {y}_{c} = ( \frac{1}{{A}_{t}} ) {\sum }_{i = 0}^{n - 1} {x}_{ci} {A}_{i} , ( \frac{1}{{A}_{t}} ) {\sum }_{i = 0}^{n - 1} {y}_{ci} {A}_{i}$$

$${A}_{t} = {\sum }_{i = 0}^{n - 1} {A}_{i}$$

where (x_{c}, y_{c}) is the total centroid, Aₜ is the total area, and n is the total number of points enclosing the tree cross section. Assuming that the elastic modulus (E) is constant, a pair of neutral axes may be selected to be any two orthogonal lines which pass through the area centroid of the tree cross-section.

After processor 170 has calculated the center of mass of the tree, processor 170 determines the points of interest on the periphery of the tree using the calculated center of mass. As set forth above, the points of interest determined by system 100 may be optimal sensor mounting locations for sensors 180 of system 100. An exemplary algorithm for calculating points of interest in such an embodiment is set forth below in accordance with aspects of the present invention.

Processor 170 determines points of interest on the periphery of the tree through the use of one or more lines passing through the center of mass of the tree (as calculated by processor 170). For one example, processor 170 may be programmed to determine two points of interest on the periphery of the tree. In this case, processor 170 may generate a single line (extending in an arbitrary direction) through the center of mass of the tree. The processor 170 then determines the two points of interest by identifying points at which the line through the center of mass of the tree 190 intersects with the periphery (or outline) of the tree.

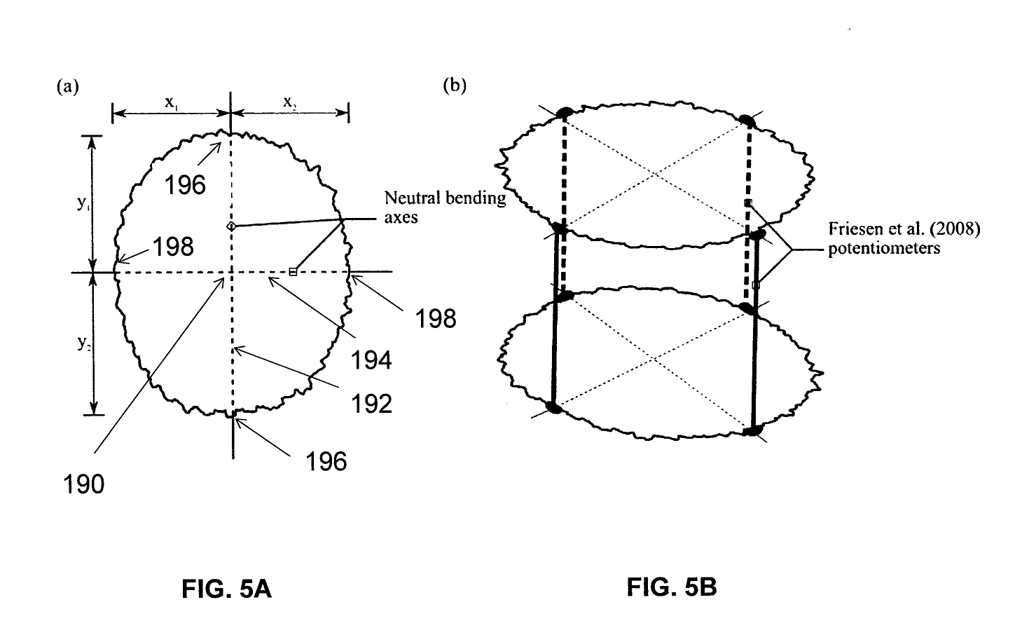

For another example, processor 170 may be programmed to determine four points of interest on the periphery of the tree. In this case, processor 170 may generate two lines 192 and 194 (extending in arbitrary but different directions) through the center of mass of the tree 190, as shown in FIG. 5A. The processor 170 then determines the four points of interest by identifying points 196 and 198 at which the lines 192 and 194 through the center of mass of the tree 190 intersect with the periphery (or outline) of the tree. As illustrated in FIG. 5A, it may be desirable that the two lines 192 and 194 be orthogonal.

An alternative algorithm for calculating points of interest on the periphery of a tree may be used for certain species of tree in which the heartwood has been found to contain high levels of soluble “hot water” extractions in comparison to the sapwood.

For these species, the points of interest may be calculated by finding the point at which the neutral bending axes intersect the periphery of the tree. The location of the neutral bending axes may be determined by meshing the cross section of the tree with internal points of a regular spacing. The mesh can then be used to compute a Delaunay triangulation for the combined internal and external section points. Each element in the mesh may be assigned a weighted E based on its distance from the section centroid, or alternately, the distance to the closest exterior point of the section. The location of the neutral axis of bending parallel to the y-direction, for example, is then found by numerically solving the following equation:

$${\sum }_{j = 0}^{n} {E}_{j} {\int }_{j} y d A = 0$$

where the integrated area of element j and Ej is the unique elastic modulus assigned to each element j for the total number of elements n.

The operation of system 100 may include further aspects when system 100 includes an indicator and sensors 180, as described above. After determining the points of interest as set forth above, processor 170 controls advancement mechanism 140 to move carriage 130 into a position in which the indicator (e.g., transmitter 152) can indicate the location of the points of interest to a user of system 100. Processor 170 then operates the indicator to identify the points of interest on the periphery of the object. The user may then mount a sensor 180 at each of the points of interest identified by processor 170. The process may then be repeated at other cross-sections along the trunk of the tree, if desired, to obtain measurements at multiple different axially-spaced cross-sections of the trunk, as shown in FIG. 5B.

Once sensors 180 are installed, the distances of each sensor 180 to neutral bending axes may be used in conjunction with strain measurements to calculate the compressive forces experienced by sensors 180. By assuming the tree trunks act orthotropically, the non-shear strain on the tree may be calculated using the following equation:

$${ɛ}_{c} = {d}_{2} ( \frac{{ɛ}_{1} - {ɛ}_{2}}{{d}_{1} + {d}_{2}} ) + {ɛ}_{2}$$

where ε_{c} is the non-shear strain between the shear strains of the two orthogonally-aligned measurements ε₁ and ε₂ at the vertical and horizontal distances d₁ and d₂ from the neutral bending axes. These computations may be done for each set of axes and averaged to allow for an accurate measurement of non-shear strain regardless of wind direction.

Compressive strain can be converted into a measurement of compressive force through Hooke's law coupled with the area of the cross section:

F=Eε_{c}Aₜ

in which F is the compressive force measured from the interpolated strain (ε_{c}) over the total cross sectional area (Aₜ) with the elastic modulus (E).

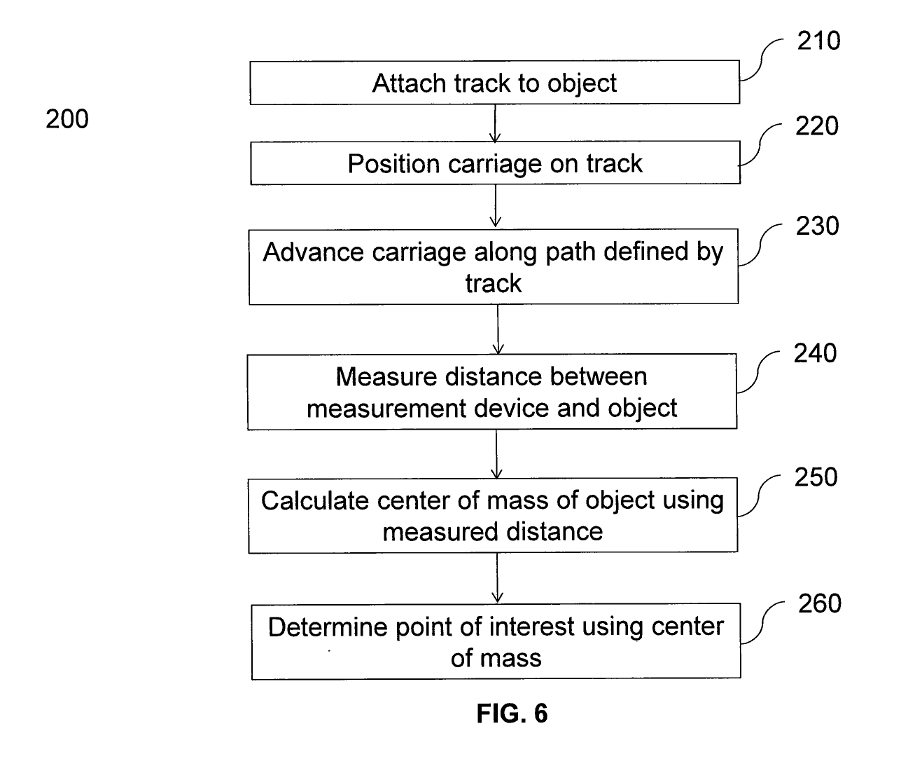

FIG. 6 is a flowchart illustrating an exemplary method 200 for identifying a point of interest on a periphery of an object in accordance with aspects of the present invention. Method 200 may be particularly suitable to identify suitable sensor mounting locations on the trunk of a tree. As a general overview, method 200 includes attaching a track to the object, positioning a carriage on the track, advancing the carriage, measuring a distance to the object, calculating a center of mass of the object, and determining the point of interest on the object. Additional details of method 200 are described herein with respect to the components of powered mobility system 100.

In step 210, a track is attached to the object. In an exemplary embodiment, track 110 is attached to the object using anchors 116. Track 110 defines a path around at least a portion of the object. Track 110 is preferably attached to the object using a level, to ensure accurate and precise measurements along the periphery of the object.

In step 220, a carriage is positioned on the track. In an exemplary embodiment, carriage 130 is positioned on the path defined by track 110. Carriage 130 is adapted to traverse the path. Non-contact measurement device 150 is mounted on carriage 130.

In step 230, the carriage is advanced along the path. In an exemplary embodiment, carriage 130 is advanced along the path defined by track 110 using advancement mechanism 140. Processor 170 may be programmed to control advancement mechanism 140 to advance carriage 130 along the path. Processor 170 may further be programmed to keep track of the position of carriage 130 on track 110 (i.e., how far carriage 130 has advanced), in order to determine when carriage 130 has made a full revolution around track 110.

In step 240, a distance is measured. In an exemplary embodiment, processor 170 is programmed to measure the distance between measurement device 150 and the periphery of the object using measurement device 150. Measurement device 150 performs measurements by projecting a beam of radiation onto the periphery of the object with transmitter 152, and capturing image data from the periphery of the object with detector 154. Processor 170 may then triangulate the distance to the object based on the location of the reflected radiation in the image data. Processor 170 may measure this distance at a plurality of locations along the path defined by track 110.

In step 250, a center of mass of the object is calculated. In an exemplary embodiment, processor 170 calculates a center of mass of the object using the distances measured in step 240. Processor 170 may use any of the algorithms described above to calculate the center of mass.

In step 260, the point of interest is determined. In an exemplary embodiment, processor 170 determines a point of interest on the periphery of the object using the center of mass calculated in step 250. Processor 170 may use any of the algorithms described above to determine the point of interest.

Method 200 is not limited to the above steps, but may include alternative steps and additional steps, as would be understood by one of ordinary skill in the art from the description herein.

For one example, system 100 may include an indicator adapted to optically indicate the location of the points of interest on the periphery of the object. Accordingly, in this embodiment, method 200 may further comprise the step of identifying the point of interest on the periphery of the object using the optical indicator (e.g., transmitter 152) mounted on carriage 130.

For another example, system 100 may include sensors 180 for mounting on the periphery of the object. Accordingly, in this embodiment, method 200 may further comprise the step of mounting sensor 180 on the periphery of the object at the point of interest identified by the indicator.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for identifying a point of interest on a periphery of an object, the system comprising:
a track configured to be attached to the object, the track defining a path around at least a portion of the object;
a carriage adapted to traverse the path defined by the track;
an advancement mechanism configured to advance the carriage along the path;
a non-contact measurement device mounted on the carriage, the non-contact measurement device comprising a transmitter configured to transmit a beam of radiation toward the periphery of the object and a detector configured to detect at least a portion of the radiation reflected from the periphery of the object;
a processor in communication with the measurement device, the processor programmed to (i) control the advancement mechanism to advance the carriage along the path, (ii) measure a distance between the periphery of the object and the measurement device at a plurality of locations of the carriage along the path, (iii) calculate a center of mass of the object from the measured distances, and (iv) determine the point of interest on the periphery of the object using the calculated center of mass of the object.

2. The system of claim 1, wherein the path is a fixed distance from a central axis of the object.

3. The system of claim 2, wherein the path has a ring shape completely surrounding the central axis of the object.

4. The system of claim 1, wherein
the path is disposed within a single plane, and
the processor is programmed to automatically calculate the center of mass of the object in the single plane.

5. The system of claim 1, wherein the processor is programmed to calculate the center of mass using the following formula:
$${x}_{c} , {y}_{c} = ( \frac{1}{{A}_{t}} ) {\sum }_{i = 0}^{n - 1} {x}_{ci} {A}_{i} , ( \frac{1}{{A}_{t}} ) {\sum }_{i = 0}^{n - 1} {y}_{ci} {A}_{i}$$
where (x_{c}, y_{c}) are coordinates of the center of mass of the object, Aₜ is a total area of a cross-section of the object, n is a total number of measurement points enclosing the cross-section of the object, (x_{ci}, y_{ci}) is a centroid of a triangle enclosed by adjacent measurement points (xᵢ, yᵢ) and (xᵢ₊₁, yᵢ₊₁) and a center of the object, and Aᵢ is the area of the triangle enclosed by the adjacent measurement points (xᵢ, yᵢ) and (xᵢ₊₁, yᵢ₊₁) and the center of the object.

6. The system of claim 1, wherein the processor is programmed to determine two points of interest on the periphery of the object, the processor determining the two points by identifying points at which a line through the center of mass of the object intersects the periphery of the object.

7. The system of claim 6, wherein the processor is programmed to determine four points of interest on the periphery of the object, the processor determining the four points by identifying points at which two lines through the center of mass of the object intersect the periphery of the object.

8. The system of claim 7, wherein the two lines are orthogonal.

9. The system of claim 1, further comprising:
an indicator mounted on the carriage, the indicator configured to identify a point on the periphery of the object,
wherein the processor is programmed to operate the indicator to identify the point of interest on the periphery of the object.

10. The system of claim 9, wherein the indicator is an optical indicator.

11. The system of claim 10, wherein the optical indicator comprises an optical laser emitter.

12. The system of claim 9, further comprising a sensor adapted to be mounted on the periphery of the object at the point of interest identified by the indicator.

13. The system of claim 12, wherein the sensor is adapted to measure a compression of the object.

14. A method for identifying a point of interest on a periphery of an object, the method comprising the steps of:
attaching a track to the object, the track defining a path around at least a portion of the object;
positioning a carriage on the path defined by the track, the carriage adapted to traverse the path, the carriage including a non-contact measurement device;
advancing the carriage along the path using an advancement mechanism coupled to the carriage;
measuring with the measurement device a distance between the periphery of the object and the measurement device at a plurality of locations of the carriage along the path;
calculating a center of mass of the object from the measured distances; and
determining the point of interest on the periphery of the object using the calculated center of mass of the object.

15. The method of claim 14, wherein the calculating step comprises calculating the center of mass using the following formula:
$${x}_{c} , {y}_{c} = ( \frac{1}{{A}_{t}} ) {\sum }_{i = 0}^{n - 1} {x}_{ci} {A}_{i} , ( \frac{1}{{A}_{t}} ) {\sum }_{i = 0}^{n - 1} {y}_{ci} {A}_{i}$$
where (x_{c}, y_{c}) are coordinates of the center of mass of the object, Aₜ is a total area of a cross-section of the object, n is a total number of measurement points enclosing the cross-section of the object, (x_{ci}, y_{ci}) is a centroid of a triangle enclosed by adjacent measurement points (xᵢ, yᵢ) and (xᵢ₊₁, yᵢ₊₁) and a center of the object, and Aᵢ is the area of the triangle enclosed by the adjacent measurement points (xᵢ, yᵢ) and (xᵢ₊₁, yᵢ₊₁) and the center of the object.

16. The method of claim 14, wherein the determining step comprises determining two points of interest on the periphery of the object by identifying points at which a line through the center of mass of the object intersects the periphery of the object.

17. The method of claim 16, wherein the determining step comprises determining four points of interest on the periphery of the object by identifying points at which two lines through the center of mass of the object intersect the periphery of the object.

18. The method of claim 17, wherein the two lines are orthogonal.

19. The method of claim 14, further comprising the step of:
identifying the point of interest on the periphery of the object using an optical indicator mounted on the carriage.

20. The method of claim 19, further comprising the step of:
mounting a compression sensor on the periphery of the object at the point of interest identified by the indicator.
